(19) United States
(12) Patent Application Publication
(10) Pub. No.: US 2009/0009498 A1
(43) Pub. Date: Jan. 8, 2009

(54) Capacitive load driving circuit, capacitive load driving method, and driving circuit for liquid crystal display device

(75) Inventor: Kouichi Nishimura, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kanagawa (JP)

(21) Appl. No.: 12/213,666

(22) Filed: Jun. 23, 2008

(30) Foreign Application Priority Data
Jul. 6, 2007 (JP) 179032/2007

(51) Int. Cl. G09G 5/00

(52) U.S. Cl. 345/205

(57) ABSTRACT

The present invention provides a driving circuit capable of exerting improved driving performance while saving power consumption. A capacitive load driving circuit includes a gate driver, which drives scan electrodes aligned in a column direction of capacitive load circuits arranged in a matrix, and a source driver, which drives data electrodes aligned in a row direction of the capacitive load circuits. The source driver includes a plurality of output circuits, which are aligned in the row direction, for driving the respective data electrodes. Each of the plurality of output circuits drives the corresponding data electrode after changing the pre-charge amount on the basis of the position of the scan electrode driven by the gate driver.

### BACKGROUND OF THE INVENTION

1. Field of the Invention

The present invention relates to a driving circuit and a driving method for driving a capacitive load, and particularly relates to a driving circuit and a driving method for a liquid crystal display device which circuit and method are for driving a capacitive load of a liquid crystal display panel or the like.

2. Description of the Related Art

Thin flat panels have been further increasing in size in the current developments. Such developments are likely to continue especially in the field of television, as can be seen from the fact that even liquid crystal panels have been produced in the size of 50 inches or larger. However, a further increase in the load on a data line of a thin film transistor (TFT) along with the increase in size of liquid crystal panels leads to a problem that data cannot be written to the data lines up to their farthest ends within one horizontal period (1H period). In order to solve the problem, conventionally taken have been measures (called a “dual bank drive” system), in which source drivers (horizontal drivers) are respectively arranged on an upper side and a lower side of the liquid crystal panel and are driven simultaneously. However, in the dual bank drive system, a required number of the source drivers is doubled, and the cost is increased considerably as a result. In view of the problems, various improvements have been made in order to surely write the data to a drain line at the farthest end while employing a single bank drive system, in which a source driver is arranged to only either an upper side or a lower side of a liquid crystal panel.

FIG. 1 is a block diagram showing a configuration example of a liquid crystal display device. The liquid crystal display device has a system in which an analog data signal generated based on digital image data is applied to a liquid crystal panel. The liquid crystal display device includes a liquid crystal panel 1, a control circuit 2, a grayscale power supply circuit 3, a data electrode driving circuit (source driver) 4, and a scan electrode driving circuit (gate driver) 5.

The liquid crystal panel 1 has an active matrix drive system in which a TFT is used as a switch element. In the liquid crystal panel 1, pixels are respectively formed of regions encompassed by n (n is a natural number) scan electrodes (gate lines) 61 to 6n provided in the row direction at predetermined intervals and m (m is a natural number) data electrodes (source lines) 71 to 7m provided in the column direction at predetermined intervals. Accordingly, the number of pixels of the entire display screen is n×m. Each pixel of the liquid crystal panel 1 includes a liquid crystal capacitor 8 as an equivalent of a capacitive load, a common electrode 9, and a TFT 10 which drives the liquid crystal capacitor 8.

When the liquid crystal panel 1 is driven, a common voltage Vcom is applied to the common electrode 9. In this state, analog data signals generated on the basis of digital image data are applied to the data electrodes 71 to 7m. Further, gate pulses generated on the basis of a horizontal synchronization signal, a vertical synchronization signal, and the like are applied to the scan electrodes 61 to 6n. Accordingly, a character, an image, or the like is displayed on the display screen of the liquid crystal panel 1. In the case of a color display, an analog red data signal, a green data signal, and a blue data signal are generated respectively on the basis of red data, green data, and blue data of digital image data, and are respectively applied to the corresponding data electrodes. Description on the color display is omitted herein, since the only differences are that an information amount and the number of circuits are tripled, which is not directly related to the operation.

The control circuit 2 is configured of, for example, an application specific integrated circuit (ASIC), and is externally supplied with a dot clock signal, the horizontal synchronization signal, the vertical synchronization signal, a data enable signal, and the like. On the basis of these input signals, the control circuit 2 generates a strobe signal, a clock signal, a horizontal scan pulse signal, a polar signal, a vertical scan pulse signal, and the like, and supplies the generated signals to the source driver 4 and the gate driver 5. The strobe signal has the same cycle as that of the horizontal synchronization signal. The clock signal synchronizes with the dot clock signal at the same or a different frequency. The clock signal is used for generating a sampling pulse from the horizontal scan pulse signal in a shift register included in the source driver 4, and the like. The horizontal scan pulse signal has the same cycle as that of the horizontal synchronization signal, and is delayed by several cycles of the clock signal from the strobe signal. The polar signal is reversed for each horizontal period, i.e., for each line, for an alternating-current (AC) drive of the liquid crystal panel 1. Note that the polar signal is also reversed for each vertical synchronization period. The vertical scan pulse signal has the same cycle as that of the vertical synchronization signal.

The gate driver 5 sequentially generates the gate pulses in synchronization with the timing of the vertical scan pulse signal supplied from the control circuit 2. The gate driver 5 sequentially applies the generated gate pulses to the corresponding scan electrodes 61 to 6n of the liquid crystal panel 1.

The grayscale power supply circuit 3 includes multiple resistors, which are connected between a reference voltage and a ground by a cascade connection, and multiple voltage followers, each of which is connected to a connection point of the adjacent resistor at its input terminal. The grayscale power supply circuit 3 amplifies and buffers a grayscale voltage at the connection point of the adjacent resistor, and then supplies the resultant voltage to the source driver 4. The grayscale voltage is set for a gamma conversion. The gamma conversion originally means a correction for obtaining the opposite characteristic to that of a traditional camera tube, so that a normal image signal is consequently regained. Herein, the gamma conversion means a correction of an analog image signal or a digital image signal for obtaining a well-graded reproduction image, with the gamma of the whole system being 1. Generally, gamma conversion is performed in order to conform the analog image signal or the digital image signal to the characteristic of a CRT display, that is, to achieve compatibility. FIG. 2 shows one example of relationships (gamma conversion characteristics) of 6-bit input data (shown in hexadecimal (HEX)) with grayscale voltages V0 to V4 and V5 to V9.

As shown in FIG. 1, the source driver 4 includes an image data processing circuit 11, a digital-to-analog converter (DAC) 12, and m output circuits 131 to 13m.

The image data processing circuit 11 includes a shift register, a data register, a latch circuit, and a level shifter circuit (which are not shown). The shift register is a serial-in/parallel-out shift register configured of multiple delay flip-flops. The shift register performs a shift operation in which the horizontal scan pulse signal supplied from the control circuit 2 is shifted in synchronization with the clock signal supplied from the control circuit 2, and outputs multiple bits of parallel sampling pulses. The data register receives, as display data, data of the digital image data signal supplied externally, in synchronization with the sampling pulses supplied from the shift register, and supplies the display data to the latch circuit. The latch circuit receives the display data supplied from the data register in synchronization with a rising edge of the strobe signal supplied from the control circuit 2. Until the next strobe signal is supplied, i.e., in one horizontal period, the latch circuit keeps the received display data. The level shifter circuit converts the voltage of output data of the latch circuit, and then outputs the voltage-converted display data.

The DAC 12 gives a gamma-corrected grayscale characteristic to the voltage-converted display data supplied from the image data processing circuit 11 on the basis of a set of the grayscale voltages V0 to V4 or the grayscale voltages V5 to V9 supplied from the grayscale power supply circuit 3. The DAC 12 then converts gamma-corrected correction data to analog data signals, and supplies the analog data signals to the corresponding output circuits 131 to 13m.

The output circuits 131 to 13m have the same configuration, and are hence generically referred to simply as an output circuit 13. The data electrodes (source lines) 71 to 7m are generically referred to simply as a data electrode 7. The output circuit 13 includes voltage followers 141 and 142 and switches 151 and 152, as shown in FIG. 3, and drives the data electrode 7.

The switch 151 closes the circuit when a polar signal POL supplied from the control circuit 2 is in a high logic state, and applies a data signal of a positive polarity supplied from the voltage follower 141, to the corresponding data electrode 7 of the liquid crystal panel 1. The switch 152 closes the circuit when the polar signal POL supplied from the control circuit 2 is in a low logic state, and applies the data signal S of a negative polarity supplied from the voltage follower 142, to the corresponding data electrode 7 of the liquid crystal panel 1.

As shown in FIG. 4, the voltage follower 141 includes a class A amplifier including n-channel metal oxide semiconductor (MOS) transistors MN1 and MN2, p-channel MOS transistors MP1 to MP3, constant current supplies CI1 and CI2, and a capacitor C1. The voltage follower 141 amplifies and buffers a data signal of a positive polarity supplied from the DAC 12 to a corresponding input terminal Vin, and then outputs the resultant signal from an output terminal Vout.

As shown in FIG. 5, the voltage follower 142 includes a class A amplifier including p-channel MOS transistors MP4 and MP5, n-channel MOS transistors MN3 to MN5, constant current supplies CI3 and C14, and a capacitor C2. The voltage follower 142 amplifies and buffers a data signal of a negative polarity supplied from the DAC 12 to a corresponding input terminal Vin, and outputs the resultant signal from an output terminal Vout.

Next, the operation of the liquid crystal display device will be described with reference to a timing chart shown in FIG. 6. In FIG. 6, a period TF indicates one frame period, and a period TH indicates one horizontal period. A dot inversion driving method is employed as a driving method for driving the liquid crystal panel 1. Specifically, the polarity of the voltages applied to the data electrodes 71 to 7m are inverted for each dot (pixel) with respect to the common voltage Vcom applied to the common electrode 9. When a voltage of the same polarity is continuously applied to a liquid crystal cell, the liquid crystal panel generally experiences a phenomenon called “image sticking,” in which the trace of a character or the like remains on the screen even after the power is turned off. The dot inversion driving method has been employed conventionally in order to prevent the “image sticking” of the liquid crystal panel. Generally, in a liquid crystal panel, a liquid crystal cell exhibits an approximately constant transmission characteristic even when the polarity of the voltage applied to the liquid crystal cell is reversed. Thus, when the inversion driving method is employed, it is general to use the grayscale voltages of the positive polarity and the negative polarity which voltages have the same voltage values (that is, voltages of positive/negative polarity with the same absolute values with respect to the common voltage Vcom).

A clock signal VCK shown in (1) of FIG. 6 is a clock signal having a cycle TH used in the gate driver 5. Here, the period TH indicates one horizontal period. As shown in (2) to (4) of FIG. 6, the gate driver 5 sequentially generates gate-pulses VG1, VG2, . . . , and VGn respectively for lines in synchronization with corresponding pulses P1, P2, . . . , and Pn of the clock signal VCK, and then sequentially applies the gate pulses to the corresponding scan electrodes 61, 62, . . . , and 6n of the liquid crystal panel 1.

As shown in (5) and (6) of FIG. 6, the source driver 4 outputs a data signal from each of the output circuits 131, 132, . . . , and 13n to corresponding one of the data electrodes 71, 72, . . . , and 7n. Each data signal is outputted several microseconds after the corresponding one of the gate pulse VG1, VG2, . . . , and VGn is generated. Note that a data signal VSeven shown in (5) of FIG. 6 shows the data signal outputted from the even-numbered output circuits 13(2i), and a data signal VSodd shown in (6) of FIG. 6 shows the data signal outputted from the odd-numbered output circuits 13(2i-1). In other words, data signals VS2, VS4, . . . , and V5(2i) outputted respectively from the output circuits 132, 134, . . . , and 13(2i) to the data electrodes 72, 74, . . . , and 7 (2i) are generically referred to as a data signal VSeven. Data signals VS1, VS3, . . . , and VS(2i-1) outputted respectively from the output circuits 131, 133, . . . , and 13(2i-1) to the data electrodes 71, 73, . . . , and 7(2i-1) are generically referred to as a data signal VSodd.

In this manner, the output circuit 13 switches the voltage followers 141 and 142 in accordance with the positive polarity or the negative polarity, to drive the liquid crystal panel 1. The class A amplifier shown in FIG. 4 serving as the voltage follower 141 and the class A amplifier shown in FIG. 5 serving as the voltage follower 142 have different offset voltages. As a result, a so-called output deviation is caused which affects image quality. This is attributed to the fact that the amplifier for positive-polarity signals and the amplifier for negative-polarity signals are operated in accordance with the switching of polarities. It is natural that the offset voltages vary between two amplifiers. Accordingly, variation appears in the driving voltage, as the output deviation, and consequently appears on the screen, as an image quality de gray scale phenomenon such as a vertical streak.

The amplifiers shown in FIGS. 4 and 5 are class A amplifiers which consume large amounts of power due to constant flow of idling current. The idling current is mainly current from the constant current supply CI2 for the amplifier shown in FIG. 4, and current of the constant current supply CI4 for the amplifier shown in FIG. 5.

In the case of driving a recent large liquid crystal panel, the amplifier is required to have a high output driving capability due to an increase in the capacitive load which the amplifier is to drive. In order to increase the output driving capability, it is necessary to increase the size of an output transistor and consequently to increase the size of a chip. Further, in the case of driving a recent super-large liquid crystal panel, it has been difficult to drive the data line on the farthest end, which is most distant from the data line to which the amplifier is connected. For this reason, the dual bank drive system, in which the apparent load is reduced by mounting LCD drivers LSIs respectively on the upper and lower side of a liquid crystal module and then simultaneously operating the upper and lower LCD drivers to drive the liquid crystal panel, has been used. However, the required number of the LCD drivers is doubled compared to that of a conventional liquid crystal panel. This causes an increase in cost of the liquid crystal panel.

As an example of a circuit which drives the capacitive load, Japanese Patent Application Publication No. 2002-34234 discloses a technique relating a direct current-to-direct current (DC/DC) converter which operates on the principle of a charge pump. The DC/DC converter includes a first capacitor, a second capacitor, a control circuit, a fifth metal oxide semiconductor field effect transistor (MOSFET), a third controllable switch, a second controllable switch, and a comparator. The first capacitor has one electrode connected to an input of the converter via a first MOSFET and to the ground via a second MOSFET, and the other electrode connected to an input of the converter via a third MOSFET and to an output of the converter via a fourth MOSFET. The second capacitor is connected between the output of the converter and the ground. The control circuit is connected to the gates of the four MOSFETs.

The control circuit includes an oscillator functioning together with a charge pump, which is activated to transmit a signal to turn on the second and third MOSFETs in a charge phase of the charge pump and a signal to turn on the first and fourth MOSFETs in a discharge phase of the charge pump. The fifth MOSFET is connected to the input of the converter at its drain, is connected to the ground at its source via a current supply, and is connected, at its gate, to the source and a gate of the third MOSFET via the first controllable switch. The third controllable switch is connected to the gate of the second MOSFET. The second controllable switch is connected to the gate of the fourth MOSFET.

The comparator has one input connected to an output of the converter, and the other input connected to a reference voltage. When an output voltage is lower than the reference voltage, the comparator outputs a first control signal to the controllable switches and the control circuit. Thereby, a signal to turn on the first controllable switch is transmitted. The second and third controllable switches are operated to transmit signals to turn on the second MOSFET and the fourth MOSFET, whereby the charge pump is deactivated. When an output voltage is higher than the reference voltage, the comparator outputs a second control signal to the controllable switches and the control circuit. Thereby, a signal to turn off the first controllable switch is transmitted. The second and third controllable switches are operated to transmit signals to turn off the second MOSFET and the fourth MOSFET, whereby the charge pump is activated.

Japanese Patent Application Publication No. 2005-99170 discloses a driving circuit including an amplification circuit and first and second transistors having different conductivity types. The amplification circuit receives an input signal. The first and second transistors of the different conductivity types are connected in series between two power supply terminals in a way that their sources are connected to an output point. The output point is push-pull driven in response to an output signal from the amplification circuit. A signal from the output point is returned to the amplification circuit. The first and second transistors are push-pull driven on the basis of a class B operation.

### SUMMARY OF THE INVENTION

As described above, operation of the class A operation amplifier for positive polarity requires large power consumption. The present invention provides a driving circuit capable of exerting improved driving performance while saving power consumption.

Means for solving the above-described problems will be described below with reference numerals and symbols to be used in the section of “DETAILED DESCRIPTION OF THE PREFERRED EMBODIMENTS.” The reference numerals and symbols are assigned for clarifying correspondence relationships between the descriptions of the “claims” and the section of “DETAILED DESCRIPTION OF THE PREFERRED EMBODIMENTS.” Note that the reference numerals and symbols are not to be used for construing the technical scope of the invention described in the “claims.”

According to an aspect of the present invention, a capacitive load driving circuit includes: a gate driver 5, which drives scan electrodes aligned in a column direction of capacitive load circuits arranged in a matrix; and a source driver 4, which drives data electrodes 7 aligned in a row direction of the capacitive load circuits. The source driver includes output circuits 13, which are aligned in the row direction for respectively driving the data electrodes 7. Each of the output circuits 13 drives the corresponding data electrode 7 after changing a pre-charge amount on the basis of a position of the scan electrode 6 driven by the gate driver 5.

According to another aspect of the present invention, a capacitive load driving method includes a gate driving step and a source driving step. The gate driving step is a step of driving scan electrodes aligned in a column direction of capacitive load circuits arranged in a matrix. The source driving step is a step of driving each of the data electrodes aligned in a row direction of the capacitive load circuits by changing a pre-charge amount on the basis of the position of the scan electrode driven in the gate driving step.

According to the present invention, a driving circuit capable of exerting improved driving performance while saving power consumption can be provided. Moreover, a driving circuit which has an improved driving characteristic for driving a capacitive load can be provided. Further, a driving circuit which enables cost reduction can be provided.

### BRIEF DESCRIPTION OF THE DRAWINGS

FIG. 1 is a block diagram showing a configuration example of a liquid crystal display device.

FIG. 2 is a view showing one example of relationships of 6-bit input data with grayscale voltages V0 to V4 and V5 to V9.

FIG. 3 is a circuit diagram showing a configuration example of an output circuit 13.

FIG. 4 is a circuit diagram showing a configuration example (1) of a voltage follower composing the output circuit.

FIG. 5 is a circuit diagram showing a configuration example (2) of the voltage follower composing the output circuit.

FIG. 6 is a timing chart for illustrating an operation of the liquid crystal display device.

FIG. 7 is a block diagram showing a configuration example of an output circuit according to a first embodiment of the present invention.

FIG. 8 is a circuit diagram showing a configuration of an LCD-driving amplification circuit according to the first embodiment of the present invention.

FIG. 9 is a block diagram showing a configuration of a switch time control circuit according to the first embodiment of the present invention.

FIG. 10 is a circuit diagram showing a configuration of a switch control circuit according to the first embodiment of the present invention.

FIG. 11 is a view showing relationships of operation ranges with necessity of a pre-charge (overdrive), according to the first embodiment of the present invention.

FIGS. 12A and 12B are views showing examples of output drive waveforms according to the first embodiment of the present invention.

FIG. 13 is a timing chart when a pre-charge (overdrive) is not performed, according to the first embodiment of the present invention.

FIG. 14 is a timing chart when a pre-charge (overdrive) is performed, according to the first embodiment of the present invention.

FIGS. 15A and 15B are views showing an example in which the output drive waveforms differ depending on the driven row, according to the first embodiment of the present invention.

FIGS. 16A to 16D are view schematically showing relationships of pre-charge periods and driving timings of a gate driver, according to the first embodiment of the present invention.

FIG. 17 is a block diagram showing a configuration of an output circuit according to a second embodiment of the present invention.

FIG. 18 is a block diagram showing a configuration of a pre-charge voltage control circuit according to the second embodiment of the present invention.

FIG. 19 is a circuit diagram showing a configuration of an LCD-driving amplification circuit according to the second embodiment of the present invention.

FIGS. 20A and 20B are views showing examples of output drive waveforms according to the second embodiment of the present invention.

### DETAILED DESCRIPTION OF THE PREFERRED EMBODIMENTS

### First Embodiment

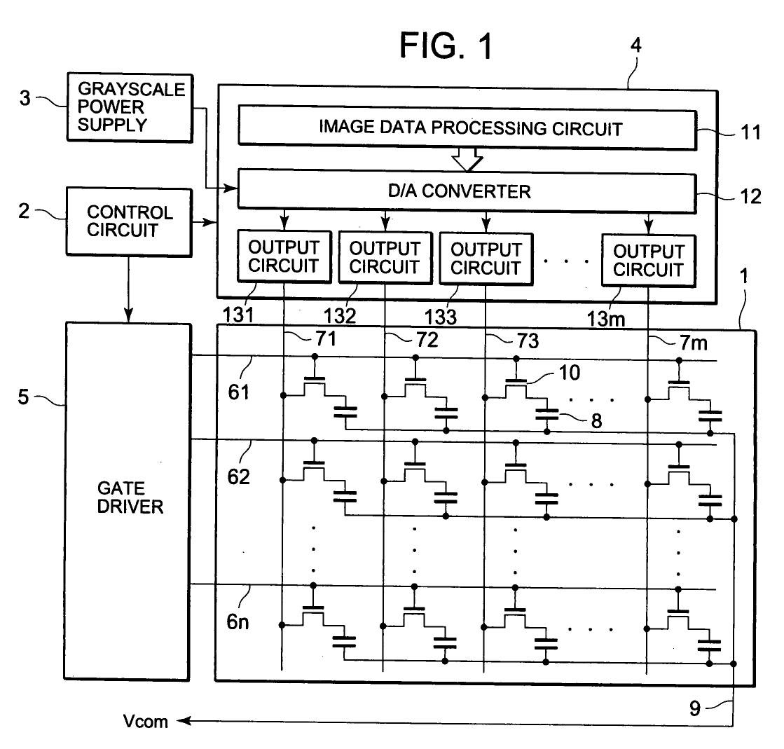

FIG. 1 is a block diagram showing a configuration of a liquid crystal display device according to a first embodiment of the present invention. The configuration of this liquid crystal display device is the same as that of the liquid crystal display device described in the section describing the related art, but will be described below once again. The liquid crystal display device according to the first embodiment has a system in which an analog data signal generated based on digital image data is applied to a liquid crystal panel. The liquid crystal display device includes a liquid crystal panel 1, a control circuit 2, a grayscale power supply circuit 3, a data electrode driving circuit (source driver) 4, and a scan electrode driving circuit (gate driver) 5.

The liquid crystal panel 1 has an active matrix drive system in which a thin film transistor (TFT) is used as a switch element. In the liquid crystal panel 1, pixels are respectively formed of regions encompassed by n (n is a natural number) scan electrodes (gate lines) 61 to 6n provided in the row direction at predetermined intervals and m (m is a natural number) data electrodes (source lines) 71 to 7m provided in the column direction at predetermined intervals. Accordingly, the number of pixels of the entire display screen is n×m. Each pixel of the liquid crystal panel 1 includes a liquid crystal capacitor 8 as an equivalent of a capacitive load, a common electrode 9, and a TFT 10 which drives the liquid crystal capacitor 8.

When the liquid crystal panel 1 is driven, a common voltage Vcom is applied to the common electrode 9. In this state, analog data signals generated on the basis of digital image data are applied to the data electrodes 71 to 7m. Further, gate pulses generated on the basis of a horizontal synchronization signal, a vertical synchronization signal, and the like are applied to the scan electrodes 61 to 6n. Accordingly, a character, an image, or the like is displayed on the display screen of the liquid crystal panel 1. In the case of a color display, an analog red data signal, a green data signal, and a blue data signal are generated respectively on the basis of red data, green data, and blue data of digital image data, and are applied to the corresponding data electrode. Description on the color display is omitted herein, since the only differences are that an information amount and the number of circuits are tripled, which is not directly related to the operation.

The control circuit 2 is externally supplied with a dot clock signal, the horizontal synchronization signal, the vertical synchronization signal, a data enable signal, and the like. On the basis of these input signals, the control circuit 2 generates a strobe signal, a clock signal, a horizontal scan pulse signal, a polar signal, a vertical scan pulse signal, and the like, and supplies the generated signals to the source driver 4 and the gate driver 5. The strobe signal has the same cycle as that of the horizontal synchronization signal. The clock signal synchronizes with the dot clock signal at the same or a different frequency. The clock signal is used for generating a sampling pulse from the horizontal scan pulse signal in a shift register included in the source driver 4, and the like. The horizontal scan pulse signal has the same cycle as that of the horizontal synchronization signal, and is delayed by several cycles of the clock signal from the strobe signal. The polar signal is reversed for each horizontal period, i.e., for each line, for an AC drive of the liquid crystal panel 1. Note that the polar signal is also reversed for each vertical synchronization period. The vertical scan pulse signal has the same cycle as that of the vertical synchronization signal.

The gate driver 5 sequentially generates the gate pulses in synchronization with the timing of the vertical scan pulse signal supplied from the control circuit 2. The gate driver 5 sequentially applies the generated gate pulses to the corresponding scan electrodes 61 to 6n of the liquid crystal panel 1.

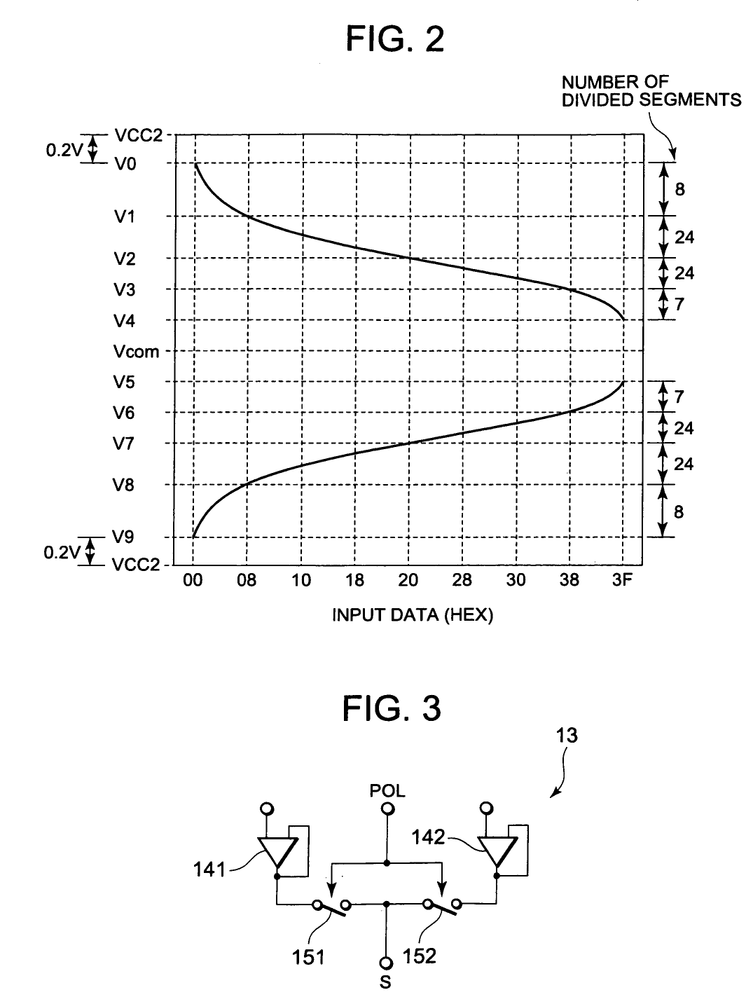

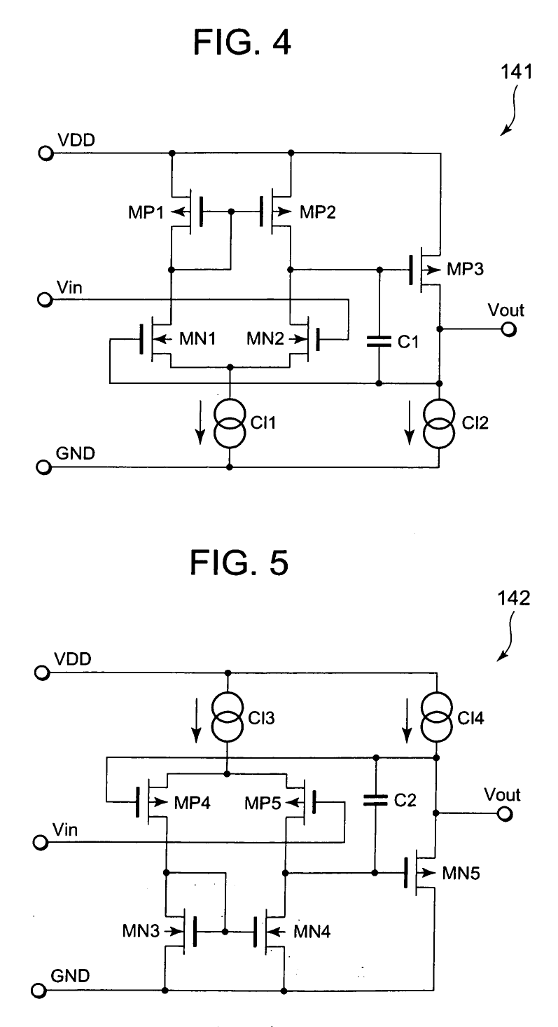

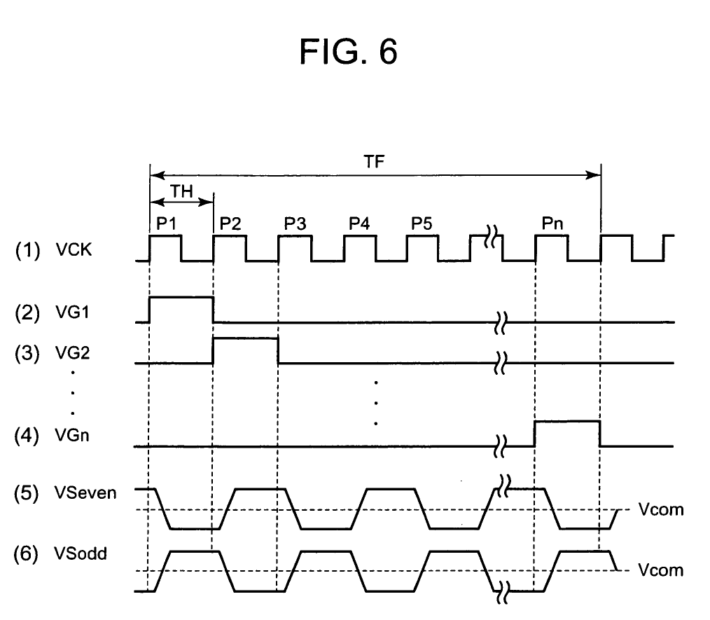

The grayscale power supply circuit 3 includes multiple resistors, which are connected between a reference voltage and a ground by a cascade connection, and multiple voltage followers, each of which is connected to a connection point of the adjacent resistor at its input terminal. The grayscale power supply circuit 3 amplifies and buffers a grayscale voltage at the connection point of the adjacent resistor, and then supplies the resultant voltage to the source driver 4. The grayscale voltage is set for a gamma conversion. The gamma conversion originally means a correction for obtaining an opposite characteristic to that of a traditional camera tube, so that a normal image signal is consequently regained. Herein, the gamma conversion means a correction of an analog image signal or a digital image signal for obtaining a well-graded reproduction image, with the gamma of the whole system being 1. Generally, gamma conversion is performed in order to conform the analog image signal or the digital image signal to the characteristic of a CRT display, that is, to achieve compatibility. FIG. 2 shows one example of relationships (gamma conversion characteristics) of 6-bit input data (shown in hexadecimal (HEX)) with grayscale voltages V0 to V4 and V5 to V9.

As shown in FIG. 1, the source driver 4 includes an image data processing circuit 11, a digital-to-analog converter (DAC) 12, and m output circuits 131 to 13m.

The image data processing circuit 11 includes a shift register, a data register, a latch circuit, and a level shifter circuit (which are not shown). The shift register is a serial-in/parallel-out shift register configured of multiple delay flip-flops. The shift register performs a shift operation in which the horizontal scan pulse signal supplied from the control circuit 2 is shifted in synchronization with the clock signal supplied from the control circuit 2, and outputs multiple bits of parallel sampling pulses. The data register receives, as display data, data of the digital image data signal supplied externally, in synchronization with the sampling pulses supplied from the shift register, and supplies the display data to the latch circuit. The latch circuit receives the display data supplied from the data register in synchronization with a rising edge of the strobe signal supplied from the control circuit 2. Until the next strobe signal is supplied, i.e., in one horizontal period, the latch circuit keeps the received display data. The level shifter circuit converts the voltage of output data of the latch circuit, and then outputs the voltage-converted display data.

The DAC 12 gives a gamma-corrected grayscale characteristic to the voltage-converted display data supplied from the image data processing circuit 11 on the basis of a set of the grayscale voltages V0 to V4 or the grayscale voltages V5 to V9 supplied from the grayscale power supply circuit 3. The DAC 12 then converts gamma-corrected correction data to analog data signals, and supplies the analog data signals to the corresponding output circuits 131 to 13m.

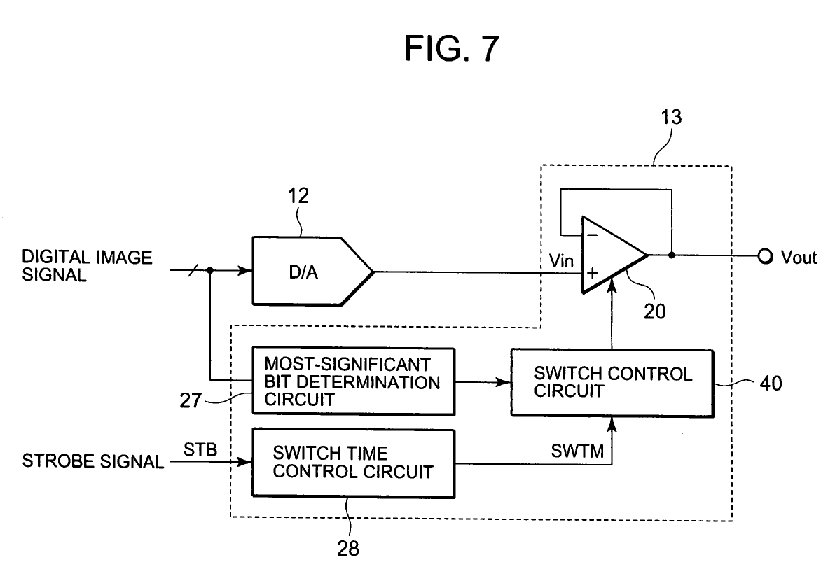

The output circuits 131 to 13m have the same configuration, and are hence generically referred to simply as an output circuit 13. The data electrodes (source lines) 71 to 7m are generically referred to simply as a data electrode (source line) 7. As shown in FIG. 7, the output circuit 13 includes a most-significant bit determination circuit 27, a switch time control circuit 28, a switch control circuit 40, and an LCD-driving amplification circuit 20. The digital image signal outputted from the image data processing circuit 11 is inputted to the DAC 12 and to the most-significant bit determination circuit 27. The output of the most-significant bit determination circuit 27 is inputted to the switch control circuit 40. A strobe signal STB outputted from the control circuit 2 is inputted to the switch time control circuit 28. The output of the switch time control circuit 28 is inputted to the switch control circuit 40. The output of the digital/analog converter 12 is inputted to the LCD-driving amplification circuit 20. The output of the switch control circuit 40 is inputted to the LCD-driving amplification circuit 20, and the LCD-driving amplification circuit 20 is thereby controlled. The LCD-driving amplification circuit 20 receives the analog signal outputted from the DAC 12, and then outputs the data signal from a load terminal Vout to the data electrode 7.

As will be described later, the LCD-driving amplification circuit 20 includes a switch for performing a pre-charge (overdrive). The switch control circuit 40 controls the opening/closing of the switch. The most-significant bit determination circuit 27 determines whether or not the pre-charge is necessary, on the basis of n most significant bits of the digital image signal. The switch time control circuit 28 sets a pre-charge time for which the switch control circuit 40 controls the opening/closing of the switch. The pre-charge time is sequentially changed according to the position of the gate line 6 driven by the gate driver 5, on the basis of the strobe signal outputted from the control circuit 2. By controlling the time of the pre-charge (overdrive), a writing time for the farthest end can be optimized. Note that a pre-charge function can be operated for all image data, when a determination operation of the most-significant bit determination circuit 27 is stopped.

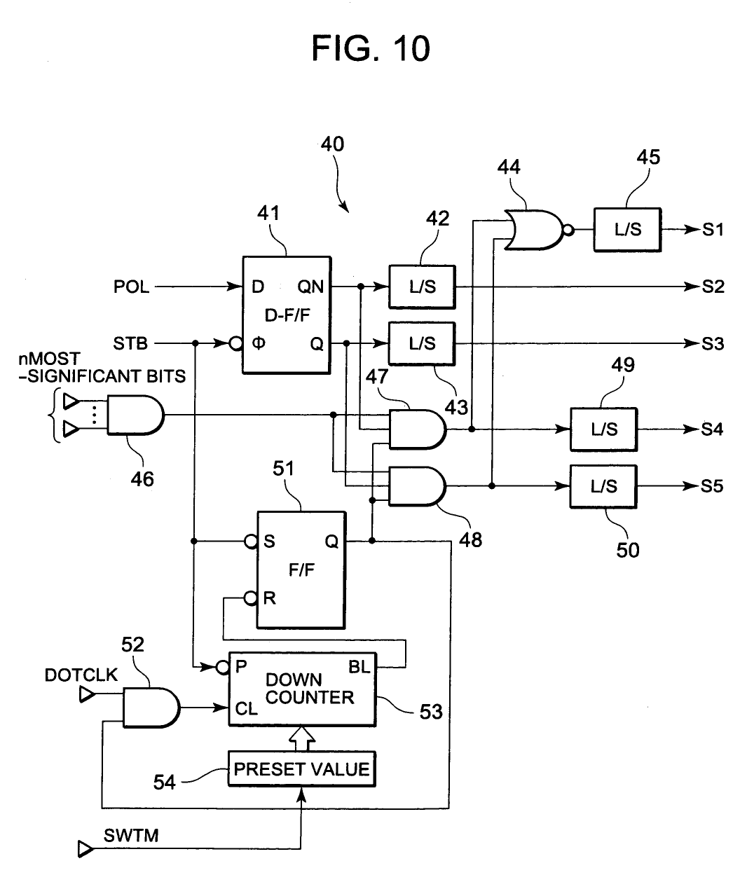

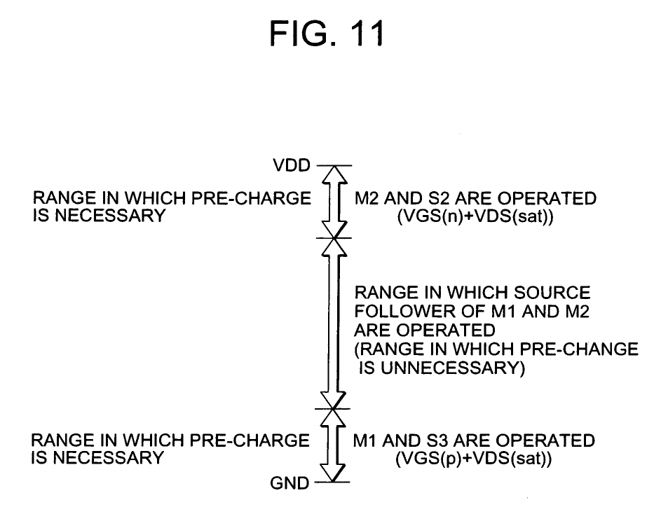

As shown in FIG. 11, the most-significant bit determination circuit 27 is a circuit which makes a distinction between input data of a region requiring a pre-charge (overdrive) and input data of a region not requiring any pre-charge (overdrive). For example, a determination on 3 most significant bits of input digital data allows a determination on whether or not the digital data falls within a range of the input data requiring a pre-charge shown in FIG. 11. As shown in FIG. 10, the most-significant bit determination circuit 27 includes an AND circuit 46. When all of the n most significant bits of the digital image signal are “1,” it is determined that the pre-charge (overdrive) is necessary, and the output of the AND circuit 46 is consequently activated. Herein, the AND circuit is illustrated as an example. However, the determination is performed by a comparator when a threshold value is an arbitrary value.

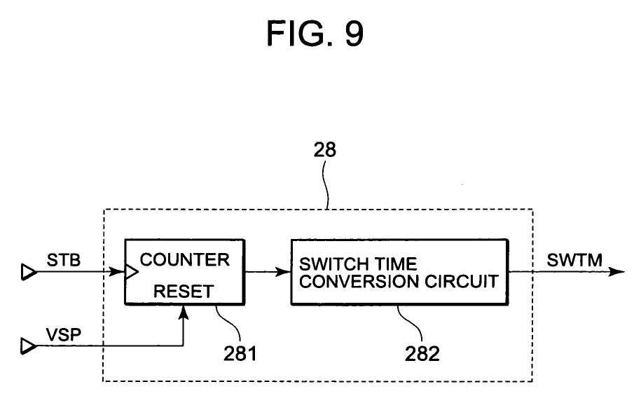

As shown in FIG. 9, the switch time control circuit 28 includes a counter 281 and a switch time conversion circuit 282. The counter 281 is a binary counter which counts a pulse number of the strobe signal STB inputted to an input terminal. A count value of the counter 281 is outputted to the switch time conversion circuit 282. The count value is cleared by a start pulse signal VSP of the gate driver 5 inputted to a reset terminal of the counter 281. Thus, the count value of the counter 281 shows the position of the gate line 6 driven by the gate driver 5 after a beginning of a driven row has been shown by the start pulse signal VSP.

The switch time conversion circuit 282 sets an opening/closing time of the switch of the LCD-driving amplification circuit 20 on the basis of the count value of the counter 281, and then outputs, to the switch control circuit 40, a signal SWTM showing the opening/closing time of the switch. The switch time conversion circuit 282 holds values showing the opening/closing time corresponding to the inputted count value, in a table. The switch time conversion circuit 282 includes several conversion tables, one of which is selected for use in accordance with the definition and the like of the liquid crystal panel 1. The conversion table is preferably selected by the control circuit 2. When a conversion relationship of the count value and the opening/closing time is shown by an arithmetic expression, the switch time conversion circuit 282 may be configured of an arithmetic circuit.

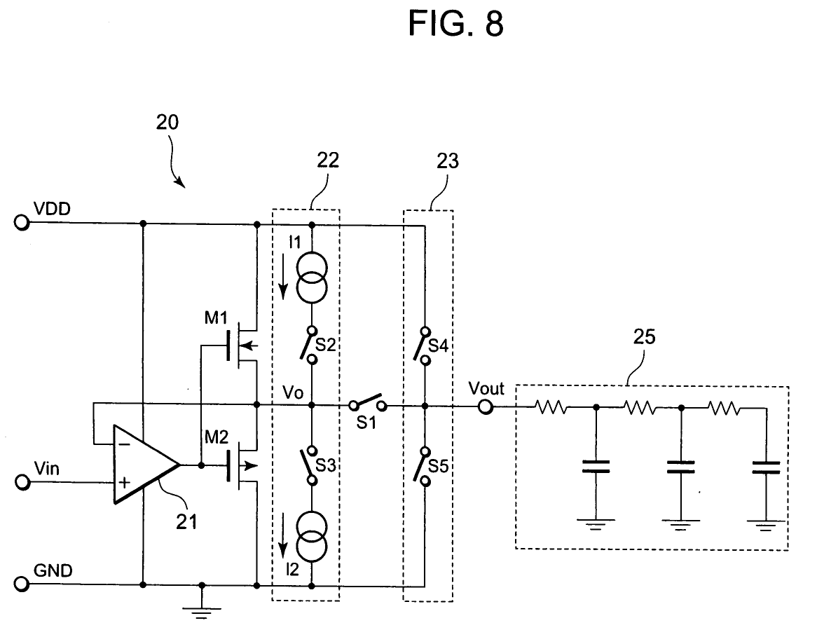

As shown in FIG. 8, the LCD-driving amplification circuit 20 includes a differential amplification section 21, an n-channel transistor M1, a p-channel transistor M2, a current supply section 22, a pre-charge switch section 23, and a switch S1. The n-channel transistor M1 and the p-channel transistor M2 form a complementary output stage of a source follower, and electrically amplify the output of the differential amplification section 21. The n-channel transistor M1 and the p-channel transistor M2 are connected to an output node Vo at their sources. The current supply section 22 includes a current supply I1, a switch S2, a switch S3, and a current supply 12, which are connected in series between a power supply VDD and a ground GND. The switch S2 is connected between the output node Vo and one end of the current supply (current source) I1, the other end of which is connected to the positive power supply VDD. The switch S3 is connected between the output node Vo and one end of the current supply (current sink) 12, the other end of which is grounded. The output node Vo is connected to the load terminal Vout via the switch S1. The pre-charge switch section 23 includes a switch S4 and a switch S5 connected in series between the power supply VDD and the ground GND. The switch S4 is connected between the positive power supply VDD and the load terminal Vout in order to perform the pre-charge. The switch S5 is connected between the ground terminal GND and the load terminal Vout in order to perform the pre-charge. The load terminal Vout, which is a connection node of the switch S4 and the switch S5, is connected to the load 25 (liquid crystal panel). The opening/closing of the switches S1 to S5 are controlled by the switch control circuit 40. The differential amplification section 21 is a rail-to-rail input/output amplifier. Such an amplifier is well known to those skilled in the art, and is not directly related to the present invention. Accordingly, detailed description thereof is omitted herein.

In a range of the input signal in which the source follower composed of the n-channel transistor M1 and the p-channel transistor M2 can be driven, the LCD-driving amplification circuit 20 performs a normal amplification operation. Thus, the LCD-driving amplification circuit 20 can have a novel capability to perform a source follower drive, which is a high driving capability with low impedance. A specific range in which the source follower drive is possible can be found by the following expression:

VDD−(VGS_{M1}+VDS(sat))≧Vin>VGS_{M2}+VDS(sat)

where VGS_{M} shows a gate-source voltage of the transistor M, and VDS (sat) shows a boundary voltage of a triode region and a pentode region of the transistor composing a previous stage or the current supply.

In a normal operation, the source follower drive cannot be performed outside this range. However, by performing the pre-charge for the load terminal Vout, a driving range can be broadened equivalently. In other words, in a range near the power supply voltage VDD, the voltage of the load terminal Vout (node Vo) temporarily rises to the power supply voltage VDD, whereby the p-channel transistor M2 comes into an operable state. Accordingly, a region in which driving has not been possible (i.e. the part described as “M2 AND S2 ARE OPERATED” in FIG. 11) consequently comes into a state in which an output is possible. Hence, an equivalent of the driving is achieved. This is made possible by the source follower of the p-channel transistor being capable of functioning not as the current source but as the current sink.

The same holds for a part near the ground voltage GND (the part described as “M1 AND S3 ARE OPERATED” in FIG. 11). Specifically, in the part near the ground voltage GND, the voltage of the load terminal Vout (node Vo) temporarily decreases to the ground voltage GND, whereby the n-channel transistor M1 comes into an operable state. This is made possible by the source follower of the n-channel transistor being capable of functioning not as the current sink but as the current source. Accordingly, an output for a range of all voltages is made possible.

The LCD-driving amplification circuit 20, which drives the source follower composed of the n-channel transistor M1 and the p-channel transistor M2, operates as the class B amplifier. Accordingly, it is necessary to close the switch S2 or the switch S3 to allow output idling current to flow. The flow of the idling current allows a gate voltage of the source follower when the output voltage is zero to be stabilized. Thus, when the switch S1 is opened, and the flow of the output idling current is thereby stopped, the switch S2 or the switch S3 is controlled to be closed so that the idling current can flow.

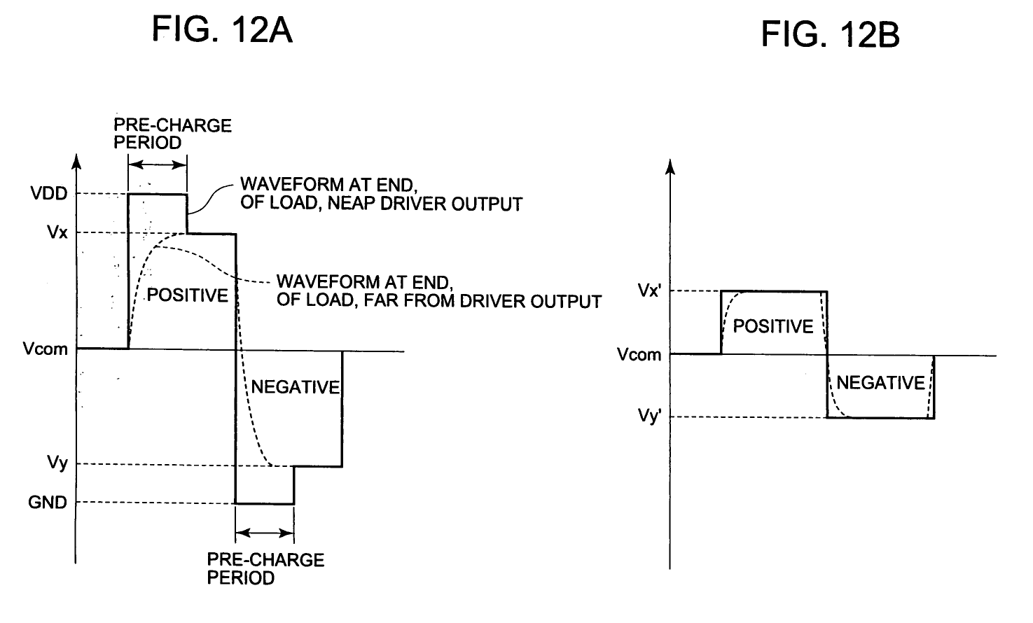

When the pre-charge (overdrive) is not necessary, the switch S4 or the switch S5 for a pre-charge control remains open. In a period of positive polarity, the switch S2 is closed, the switch S3 is opened, and the switch S1 is closed, so that a desired voltage is outputted. On the other hand, in a period of negative polarity, the switch S2 is opened, the switch S3 is closed, and the switch S1 is closed, so that a desired voltage is outputted. Accordingly, the driving allows a source follower output with feedback, and the LCD-driving amplification circuit 20 is hence configured as a circuit having a high driving capability. An output waveform as a result of these operations is shown in FIG. 12B. Note that the pre-charge (overdrive) for increasing a write speed to the liquid crystal panel may also be performed in the above-described region in which the pre-charge (overdrive) is not necessary.

When the pre-charge (overdrive) is necessary, the switches S4 and S5 of the pre-charge switch section 23 are controlled, and a first part of one horizontal period (TH) is used for performing the pre-charge (overdrive). In the period of positive polarity, the switch S4 is closed, and the switch S1 is opened for a period of the pre-charge (overdrive), whereby the output voltage temporarily rises to the power voltage VDD. Then, the switch S4 is opened, and the switch S1 is closed, whereby an operation of bringing back the output voltage to the desired voltage is performed. The driving for bring back the output voltage to the desired voltage is performed by the source follower of the p-channel transistor M2. In the period of positive polarity, the switch S2 is closed to bias the p-channel transistor M2, so that the output voltage reliably rises to the power supply voltage.

On the other hand, in the period of negative polarity, the switch S5 is closed, and the switch S1 is opened for the period of the pre-charge (overdrive), whereby the output voltage temporarily decreases to the ground voltage (GND). Then, the switch S5 is opened, and the switch S1 is closed, whereby the operation of bringing back the output voltage to the desired voltage is performed. The driving for bring back the output voltage to the desired voltage is performed by the source follower of the n-channel transistor M1. In the period of negative polarity, the switch S3 is closed to bias the n-channel transistor M1, so that the output can be reliably operated to the ground voltage (GND).

An output waveform as a result of these operations is shown in FIG. 12A. As can be seen, the waveform at a near end, i.e., near a driver output, results in having a protruding shape in the beginning of one horizontal period, but the time until a final value is reached is shortened compared to a conventional normal driving, and a high-speed writing can thus be achieved. The waveform at a far end, i.e., a distant part from the driver output (specifically, the lowermost section of an LCD module in the case where a driver is arranged on an upper section of the LCD module), does not usually have a sharp edge due to a time constant of CR in the middle toward the far end. However, a final value reaching time is shortened compared to the conventional normal driving, and a high-speed writing can thus be achieved.

As shown in FIG. 10, the switch control circuit 40 includes a D flip-flop 41, level shifter circuits 42, 43, 49, and 50, AND circuits 47, 48, and 52, a NOR circuit 44, an RS flip-flop 51, a down counter 53, and a preset value input circuit 54.

A polar signal POL is inputted to a data terminal D and a strobe signal STB is inputted to a latch terminal [ ] of the D flip-flop 41. Output signals of two output terminals Q and QN of the D flip-flop 41 are outputted via level shifter circuits 43 and 42 as control signals for the switches S3 and S2, respectively. The level shifter circuits 43 and 42 convert signals of low logic voltages (for example, 3.3 V) to those of high voltages (for example, 10V).

The strobe signal STB is inputted to a set terminal S of the RS flip-flop 51 and a data terminal P of the down counter 53. An output signal of the two-input AND circuit 52 is inputted to a clock terminal CL of the down counter 53. An output terminal BL of the down counter 53 is connected to a reset terminal R of the flip-flop 51. The output terminal Q of the RS flip-flop 51 is connected to one input terminal of the two-input AND circuit 52, as well as to an input terminal of each of three-input AND circuits 47 and 48.

A dot clock signal DOTCLK is inputted to the other input terminal of the two-input AND circuit 52. The output signal outputted from the output terminal QN of the D flip-flop 41 and an output signal of the AND circuit 46 as a determination result of the n most significant bits are inputted respectively to the other two input terminals of the three-input AND circuit 47. The output signal outputted from the output terminal Q of the D flip-flop 41 and the output signal of the AND circuit 46 as the determination result of the n most significant bits are inputted respectively to the other two input terminals of the three-input AND circuit 48. Output signals of the three-input AND circuits 47 and 48 are respectively outputted as control signals for the switches S4 and S5 via the level shifter circuits 49 and 50. The level shifter circuits 49 and 50 convert the signals of the low logic voltages to those of the high voltages.

The output signals of the three-input AND circuits 47 and 48 are inputted to the NOR circuit 44. An output signal of the NOR circuit 44 is outputted via the level shifter circuit 45 as a control signal which controls the switch S1. The level shifter circuit 45 converts the signal of the low logic voltage to that of the high voltage.

The preset value input circuit 54 sets a preset value in the down counter 53. The preset value is a value set by the switch time conversion circuit 282 of the switch time control circuit 28, and thus shows the switch opening/closing time corresponding to the position of the gate line 6 driven by the gate driver 5.

The D flip-flop 41 loads the polar signal POL applied to the data input terminal D, at a falling edge of the strobe signal STB, and outputs a signal with the same polarity as that of the polar signal POL at the time to the output terminal Q while outputting a signal with reversed polarity to the output terminal QN. The output signals outputted from the output terminals Q and QN are level-shifted by the level shifter circuits 43 and 42 to become the signals which control the opening/closing of the switches S3 and S2, respectively. In other words, one of the switches S2 and S3 is set to be in an opened state while the other is set to be in a closed state in accordance with the polarity shown by the polar signal POL.

The strobe signal STB is inputted to the set terminal S of the RS flip-flop 51, and the output terminal Q of the RS flip-flop 51 comes into a high logic state in synchronization with the falling edge of the strobe signal STB. In other words, the output terminal Q of the RS flip-flop 51 coming into the high logic state indicates the start of the horizontal period. The output terminal Q is connected to the AND circuits 47 and 48. The output of the AND circuit 46 which performs the determination on the n most significant bits and the outputs (from the output terminals Q and QN) of the D flip-flop 41 are inputted to the AND circuits 47 and 48. Thus, when all of the n most significant bits are “1” and the horizontal period is started, the output of the circuit of one of the AND circuits 47 and 48 on a polarity side to be driven comes into the high logic state, and the output of the circuit on the side not to be driven comes into a low logic state. The outputs of the AND circuits 47 and 48 are level-shifted by the level shifter circuits 49 and 50 to become signals which control the opening/closing of the switches S4 and S5, respectively. In other words, the switches S4 and S5 are closed immediately after the start of the horizontal period when there is input data having an amplitude requiring the pre-charge, whereby the pre-charge is performed.

Further, the strobe signal STB is inputted to the data terminal P of the down counter 53, and the down counter 53 counts down the pulse number of the dot clock signal DOTCLK when the strobe signal STB is in the low logic state. When the count value of the down counter 53 reaches zero, an output BL comes into the high logic state. In response to the output of the down counter 53, the RS flip-flop 51 is reset, whereby the output terminal Q comes into the low logic state. Thus, from the falling edge of the strobe signal STB until the counting down of the down counter 53 is finished, the output terminal Q of the RS flip-flop 51 shows the high logic state. In other words, the preset value set in the down counter 53 enables a control of the time in which the output terminal Q of the RS flip-flop 51 is in the high logic state.

The preset value input circuit 54 holds the signal SWTM, which is converted by the switch time conversion circuit 282 and shows the opening/closing time of the switch, and sets the down counter 53 accordingly. The preset value and the cycle of the dot clock signal DOTCLK determine the opening/closing time of the switch, i.e., the pre-charge time. The AND circuit 52 is a gate for preventing unduly operation of the down counter 53.

The NOR circuit 44 outputs the low logic state when at least one of the AND circuits 47 and 48 outputs the high logic state. The output of the NOR circuit 44 is level-shifted by the level shifter circuit 45 to control the opening/closing of the switch S1. In other words, the switch S1 is controlled to be open when one of the switch S4 and the switch S5 is closed (note that the switch S4 and switch S5 are never simultaneously closed).

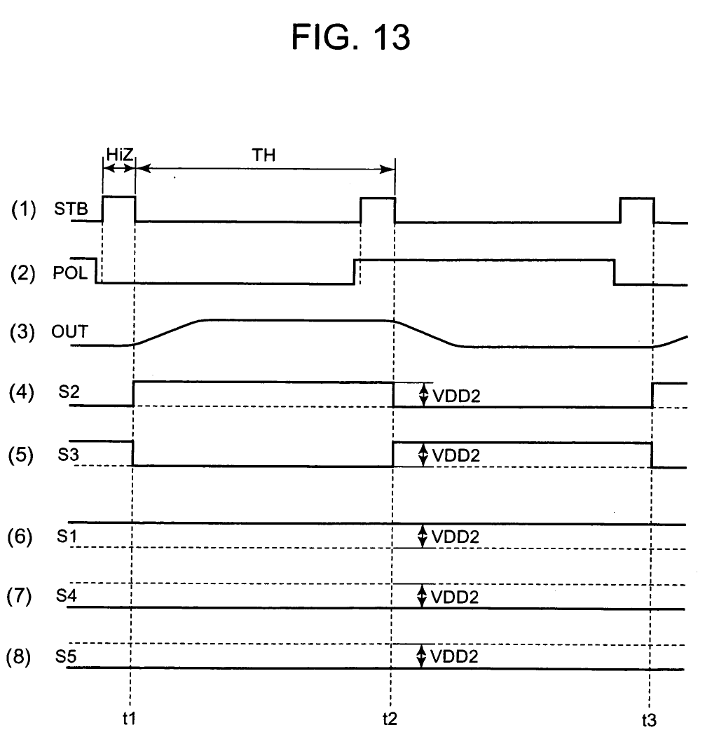

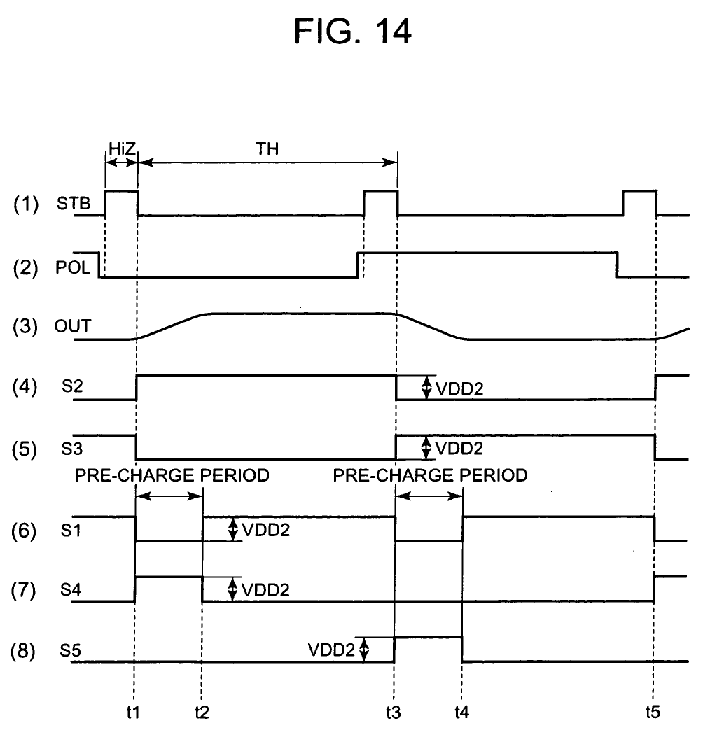

Next, the operation of the output circuit 13 will be described with reference to FIGS. 13 and 14.

In this embodiment, the output circuit 13 includes the most-significant bit determination circuit 27, and operates in a selective manner depending on whether or not the pre-charge (overdrive) is to be performed, as shown in FIG. 11. FIG. 13 is a flowchart showing a control operation of the switch when the pre-charge is not performed, and FIG. 14 is a flowchart showing a control operation of the switch when the pre-charge is performed.

The operation when the pre-charge is not performed will be described first with reference to FIG. 13. Since input data in which any of the n most significant bits includes a “0” is inputted, the output of the most-significant bit determination circuit 27, i.e., the output of the AND circuit 46, is in the low logic state. Thus, the outputs of the AND circuits 47 and 48 are both in the low logic state, whereby the switches S4 and S5 are opened ((7) and (8) of FIG. 13). The output of the NOR circuit 44 is in the high logic state, whereby the switch S1 is closed ((6) of FIG. 13). This state continues until all of the n most significant bits become “1.”

Meanwhile, the D flip-flop 41 loads and holds the polar signal POL at each falling edge of the strobe signal STB. Thus, the D flip-flop 41 alternately outputs the high logic state and the low logic state in synchronization with the falling edges of the strobe signal STB. That is, the switches S2 and S3 close or open the circuit in accordance with the polar signal POL ((4) and (5) of FIG. 13).

Since the switch S1 continues to be in a closed state, the LCD-driving amplification circuit 20 alternately outputs a positive voltage and a negative voltage with respect to the common voltage Vcom, as shown in (3) of FIG. 13. Since the load 25 is a capacitive load, drive waveforms at the rising edge and the falling edge are more obtuse.

Next, the operation when the pre-charge is performed will be described with reference to FIG. 14. Since all of the n most significant bits of the input data are set to “1,” the output of the most-significant bit determination circuit 27, i.e., the output of the AND circuit 46, is in the high logic state. Thus, the AND circuits 47 and 48 operate on the basis of the outputs of the D flip-flop 41 and the RS flip-flop 51.

The D flip-flop 41 loads and holds the polar signal POL at each falling edge of the strobe signal STB. Thus, the output signal outputted from the data terminal Q of the D flip-flop 41 is in the high logic state from time t1 to time t3, and is in the low logic state from time t3 to time t5. The output signal outputted from the data terminal QN is in the low logic state from the time t1 to time t3, and is in the high logic state from the time t3 to time t5. Thus, the control signals which control the switches S2 and S3 each repeat the opening and closing alternately in synchronization with the strobe signal STB, as shown in (4) and (5) of FIG. 14.

The output signal outputted from the output terminal Q of the RS flip-flop 51 is held in the high logic state until a signal in the high logic state is inputted to the reset terminal R from the down counter 53. Assuming that the RS flip-flop 51 is reset at times t2 and t4, the output terminal Q of the RS flip-flop 51 is in the high logic state from the time t1 to time t2, and is in the low logic state from the time t2 to time t3. Thus, the control signal controlling the switch S4 shows the high logic state from the time t1 to time t2 and then the low logic state thereafter until time t5, as shown in (7) FIG. 14. In other words, the switch S4 is closed only from the time t1 to time t2. The control signal controlling the switch S5 shows the high logic state from the time t3 to time t4, and shows the low logic state from the time t1 to time t3 and from the time t4 to time t5, as shown in (8) of FIG. 14. In other words, the switch S5 is closed only from the time t3 to time t4.

When at least one of the switches S4 and S5 is closed, the NOR circuit 44 outputs the low logic state, whereby the switch S1 is opened. Specifically, the switch S1 is opened during a period in which the switches S4 and S5 are closed to pre-charge the load 25, and is closed during other periods ((6) of FIG. 14).

Thus, during the horizontal period (t1 to t3) in which the switch S2 is closed, the switch S4 is closed only for a predetermined period immediately after the start of the horizontal period, and the load 25 is pre-charged. When the pre-charge is finished, the switch S4 is opened, the switch S1 is closed, and the operation of bringing back the output voltage to the desired voltage is thereby performed. The driving of bringing back the output voltage to the desired voltage is performed by the source follower of the p-channel transistor M2.

In the horizontal period (t3 to t5) in which the switch S3 is closed, the switch S5 is closed for a predetermined period immediately after the start of the horizontal period, and the load 25 is pre-charged. When the pre-charge is finished, the switch S5 is opened, the switch S1 is closed, and the operation of bringing back the output voltage to the desired voltage is performed. The driving of bringing back the output voltage to the desired voltage is performed by the source follower of the n-channel transistor M1.

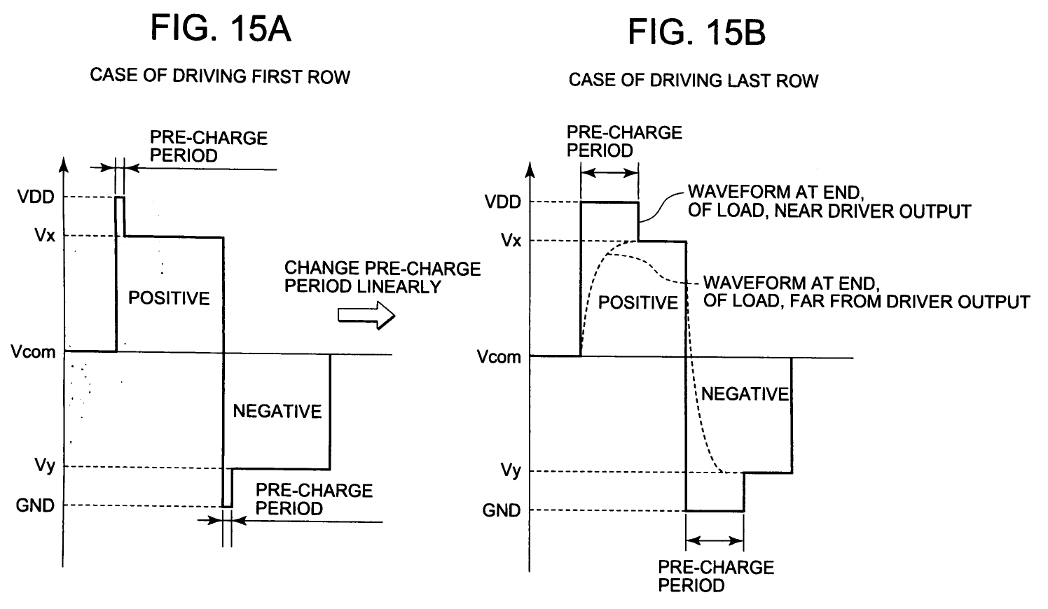

The period of pre-charge varies depending on the preset value set in the down counter 53. The preset value is set by the switch time control circuit 28. The switch time control circuit 28 counts the pulse number of the strobe signal STB, and sets the preset value on the basis of the position of the gate line 6 driven by the gate driver 5. Thus, the period of pre-charge can be set on the basis of the position of the gate line 6 driven by the gate driver 5, whereby the pre-charge period can be lengthened when the gate line 6 to be driven is distant from the output circuit 13, as shown in FIGS. 15A and 15B.

FIG. 15A shows an output waveform of the output circuit 13 when the gate line 61 of the first row is driven, where the pre-charge period is shortest. The pre-charge period for the first row or the first several rows may be zero. FIG. 15B shows an output waveform of the output circuit 13 when the gate line 6n of the last row is driven, where the pre-charge period is longest. In FIG. 15B, the waveform at a far end of the load in a position far from the output circuit 13 is shown by a dotted line.

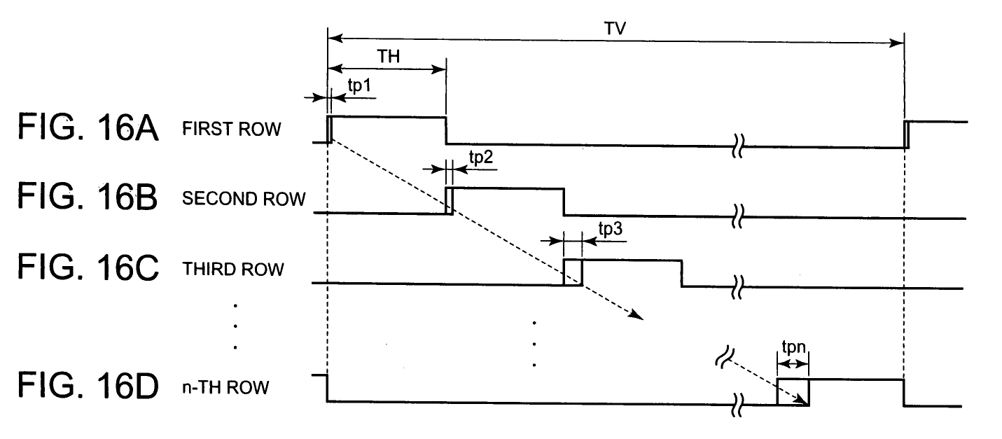

Since the gate driver 5 drives the TFT 10 to supply the output of the output circuit 13 to the liquid crystal capacitor 8, a supply state for each row of the liquid crystal capacitor 8 can be schematically shown as in FIG. 16. In other words, the pre-charge is performed for the liquid crystal capacitor 8 of the first row in a pre-charge period tp1, the pre-charge is performed for the liquid crystal capacitor 8 of the second row in a pre-charge period tp2, and the pre-charge is performed for the liquid crystal capacitor 8 of the last row in a pre-charge period tpn. The pre-charge period may increase linearly from the shortest period to the longest period, or may increase exponentially. A change amount of the pre-charge period is set by a table or an arithmetic expression of the switch time conversion circuit 282 which converts the count value of the counter 281 for counting the strobe signal STB.

In this manner, the switch time control circuit 28 sets the pre-charge period corresponding to a driving position, and the switch control circuit 40 controls the switches S1 to S5 on the basis of the pre-charge time. Thereby the writing time for the farthest end can be optimized.

### Second Embodiment

In the first embodiment described above, the voltage for pre-charge of the arithmetic amplifier having the pre-charge (overdrive) function is fixed to the positive power supply voltage (VDD) or to a negative power supply voltage (VSS), and the driving is optimized by changing the pre-charge time. In the second embodiment, the pre-charge time is constant, and the driving is optimized by changing the pre-charge voltage (i.e. voltage difference from a desired voltage). Since the only difference from the first embodiment is the output circuit 13, the description of the liquid crystal display device as a whole will be omitted below.

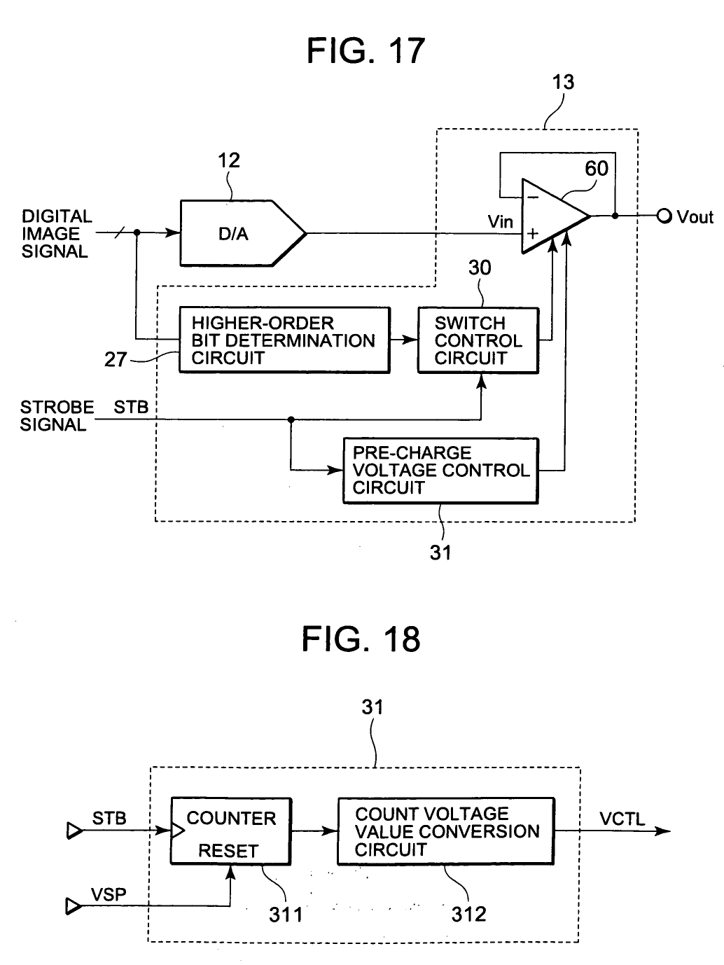

FIG. 17 shows one circuit of each of the digital/analog converter 12 and the output circuit 13 of the source driver 4. The output circuit 13 includes the most-significant bit determination circuit 27, a switch control circuit 30, a pre-charge voltage control circuit 31, and an LCD-driving amplification circuit 60. The digital image signal outputted from the image data processing circuit 11 is inputted to the DAC 12 and to the most-significant bit determination circuit 27. The output of the most-significant bit determination circuit 27 is inputted to the switch control circuit 30. The strobe signal STB outputted from the control circuit 2 is inputted to the switch control circuit 30 and the pre-charge voltage control circuit 31. The outputs of the switch control circuit 30 and the pre-charge voltage control circuit 31 are inputted to the LCD-driving amplification circuit 60. The LCD-driving amplification circuit 60 receives the analog signal from the DAC 12, and then outputs the data signal from the load terminal Vout to the data electrode 7.

As described in the first embodiment, the most-significant bit determination circuit 27 includes the AND circuit 46 shown in FIG. 10, and determines whether or not the n most significant bits of the digital image signal show predetermined values, i.e., whether or not all of the n bits show “1” in this embodiment. In a case where necessity of pre-charge does not depend on the value of the digital image signal, the most-significant bit determination circuit 27 may be omitted. While the switch control circuit 30 has the configuration shown in FIG. 10 described in the first embodiment, it is not necessary to change the pre-charge time by the driving position in the second embodiment, whereby the preset value input circuit 54 maintains a fixed value.

As shown in FIG. 18, the pre-charge voltage control circuit 31 includes a counter 311 and a count voltage value conversion circuit 312. The counter 311 is a binary counter which counts the pulse number of the strobe signal STB inputted to an input terminal. The count value of the counter 311 is outputted to the count voltage value conversion circuit 312. The count value is cleared by the start pulse signal VSP of the gate driver 5 inputted to a reset terminal of the counter 311. Thus, the count value of the counter 311 shows the position of the gate line 6 driven by the gate driver 5 after the start pulse signal VSP has shown the beginning of the driven row.

The count voltage value conversion circuit 312 sets the pre-charge voltage of the LCD-driving amplification circuit 60 on the basis of the count value of the counter 311, and then outputs a set signal VCTL to the LCD-driving amplification circuit 60. The count voltage value conversion circuit 312 holds a voltage setting value corresponding to the inputted count value in a table. The count voltage value conversion circuit 312 includes several conversion tables, one of which is selected for use in accordance with the definition and the like of the liquid crystal panel 1. The conversion table is preferably selected by the control circuit 2. When the conversion relation of the count value and the voltage value is shown by an arithmetic expression, the count voltage value conversion circuit 312 may be configured of an arithmetic circuit.

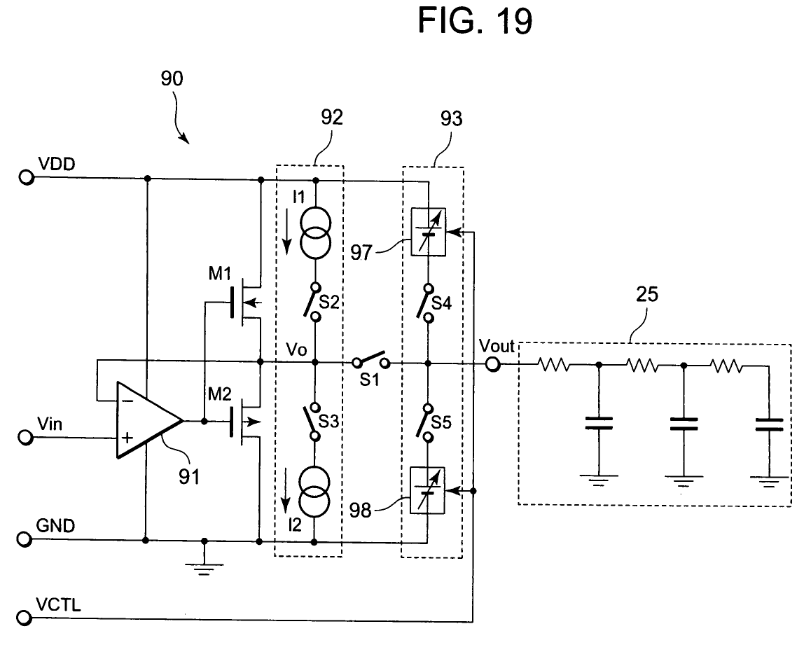

As shown in FIG. 19, the LCD-driving amplification circuit 60 includes a differential amplification section 91, the n-channel transistor M1, the p-channel transistor M2, a current source section 92, a pre-charge switch section 93, and the switch S1. The n-channel transistor M1 and the p-channel transistor M2 compose the complementary output stage of the source follower to electrically amplify the output of the differential amplification section 91. The n-channel transistor M1 and the p-channel transistor M2 are connected to the output node Vo at their sources. The current supply section 92 includes the current supply I1, the switch S2, the switch S3, and the current supply I2, which are connected in series between the power supply VDD and the ground GND. The switch S2 is connected between the output node Vo and one end of the current supply (current source) I1, the other end of which is connected to the positive power supply VDD. The switch S3 is connected between the output node Vo and one end of the current supply (current sink) 12, the other end of which is grounded. The output node Vo is connected to the load terminal Vout via the switch S1. The pre-charge switch section 93 includes a variable constant voltage source 97, the switch S4, the switch S5, and a variable constant voltage source 98, which are connected in series between the power supply VDD and the ground GND. The switch S4 is connected between the load terminal Vout and one end of the variable constant voltage source 97, the other end of which is connected to the positive power supply VDD. The switch S5 is connected between the load terminal Vout and one end of the variable constant voltage source 98, the other end of which is grounded. The load terminal Vout, which is the connection node of the switch S4 and the switch S5, is connected to the load 25 (liquid crystal panel).

The opening/closing of the switches S1 to S5 is controlled by the switch control circuit 30. The voltages of the variable constant voltage sources 97 and 98 are controlled by the pre-charge voltage control circuit 31. The variable constant voltage sources 97 and 98 may be composed of, for example, multiple power supplies and a switch. The differential amplification section 21 is the rail-to-rail input/output amplifier. Such amplifier is well known to those skilled in the art, and is not directly related to the present invention. Accordingly, description thereof is omitted herein.

The LCD-driving amplification circuit 60 operates in a similar manner to that of the LCD-driving amplification circuit 20 described in the first embodiment. The difference is that the voltage outputted from the load terminal Vout by the switch S4 and the switch S5 being closed in a pre-charge operation is a voltage set by the pre-charge voltage control circuit 31 instead of the power supply voltage VDD or the ground voltage GND. Since other operations are the same, the description of the operation of the LCD-driving amplification circuit 20 is omitted.

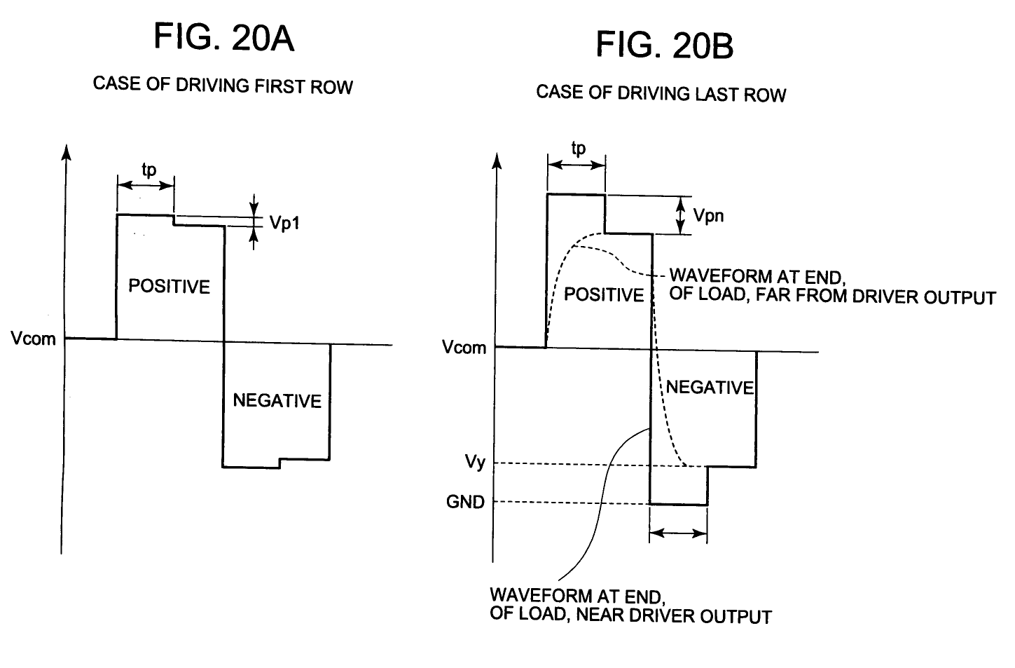

FIGS. 20A and 20B show examples of the output waveforms of the output circuit 13. FIG. 20A shows the output waveform of the output circuit 13 when the gate line 61 of the first row is driven by the gate driver 5. In this case, the pre-charge voltage is a voltage Vp1. FIG. 20B shows the output waveform of the output circuit 13 when the gate line 6n of the n-th row, i.e., the gate line of the last row, is driven by the gate driver 5. In this case, the pre-charge voltage is a voltage Vpn. The pre-charge voltage may change linearly in accordance with the driven row or may change exponentially, from the voltage Vp1 to the voltage Vpn. The change may also be stepwise.

Descriptions have been given of the output circuit in which the pre-charge time changes in accordance with the driven row in the first embodiment, and of the output circuit in which the pre-charge voltage changes in accordance with the driven row in the second embodiment. These may be combined as long as there is no contradiction.

As described above, by employing, as an LCD module, an LCD driver in which the time or the voltage for pre-charge is changed, a sufficiently high driving capability can be achieved even for a line at the farthest end which is the most distant from the LCD driver, even with the single bank drive described above of a large panel. Thus, the number of the LCD drivers can be reduced from that conventionally required, and a reduction in cost is achieved consequently.

1. A capacitive load driving circuit comprising:
a gate driver which drives scan electrodes aligned in a column direction of capacitive load circuits arranged in a matrix; and
a source driver which drives data electrodes aligned in a row direction of the capacitive load circuits, wherein
the source driver includes a plurality of output circuits aligned in the row direction for respectively driving the data electrodes, and
each of the plurality of output circuits drives the corresponding data electrode after changing a pre-charge amount on the basis of the position of the scan electrode driven by the gate driver.

2. The capacitive load driving circuit according to claim 1;
wherein each of the plurality of output circuits includes an amplitude determination circuit which determines whether or not an amplitude of image data to be inputted exceeds a predetermined threshold value, and
the amplitude determination circuit drives each of the data electrodes after changing the pre-charge amount, when determining that the amplitude of the image data exceeds the predetermined threshold value.

3. The capacitive load driving circuit according to claim 2, wherein the amplitude determination circuit makes a determination based on at least one of most significant bits of digital data showing the amplitude of the image data.

4. The capacitive load driving circuit according to claim 3, wherein
the amplitude determination circuit includes an AND circuit which receives n most significant bits of the digital data, and then outputs a logical conjunction of the n most significant bits, and,
when all of the n most significant bits are “1,” it is determined that the amplitude of the image data exceeds the predetermined threshold value, whereby each of the data electrodes is driven after the pre-charge amount is changed.

5. The capacitive load driving circuit according to claim 1, wherein each of the plurality of output circuits drives the corresponding data electrode after linearly increasing the pre-charge amount in accordance with a distance between the scan electrode driven by the gate driver and the output terminal of the output circuit.

6. The capacitive load driving circuit according to claim 1, wherein each of the plurality of output circuits drives the corresponding data electrode after exponentially increasing the pre-charge amount in accordance with a distance between the scan electrode driven by the gate driver and the output terminal of the output circuit.

7. The capacitive load driving circuit according to claim 5, wherein each of the plurality of output circuits drives the corresponding data electrode after setting the pre-charge amount at zero, when the gate driver drives the scan electrode nearest to the output terminal of the output circuit.

8. The capacitive load driving circuit according to claim 1, wherein each of the plurality of output circuits controls a pre-charge time to change the pre-charge amount, on the basis of the position of the scan electrode driven by the gate driver.

9. The capacitive load driving circuit according to claim 1, wherein each of the plurality of output circuits controls a pre-charge voltage to change the pre-charge amount, on the basis of the position of the scan electrode driven by the gate driver.

10. The driving circuit for a liquid crystal display device according to claim 1, wherein the capacitive load circuits constitute a liquid crystal panel mounted in the liquid crystal display device.

11. A capacitive load driving method comprising:
a gate driving of driving scan electrodes aligned in a column direction of capacitive load circuits arranged in a matrix; and
a source driving of driving each of data electrodes aligned in a row direction of the capacitive load circuits by changing a pre-charge amount on the basis of the position of the scan electrode driven in the gate driving.

12. The capacitive load driving method according to claim 11, further comprising:
an amplitude determination of determining whether or not the amplitude of image data to be inputted exceeds a predetermined threshold value in the source driving; and
driving each of the data electrodes by changing the pre-charge amount, when it is determined that the amplitude of the image data exceeds the threshold value in the amplitude determination.

13. The capacitive load driving method according to claim 12, wherein a determination is made on the basis of at least one of most significant bits of digital data showing the amplitude of the image data in the amplitude determination.

14. The capacitive load driving method according to claim 13, wherein the amplitude determination includes a of determining that the amplitude of the image data exceeds the predetermined threshold value when all of n most significant bits of the digital data are “1,” and then driving each of the data electrodes after changing the pre-charge amount.

15. The capacitive load driving method according to claim 11, wherein the source driving includes of driving each of the data electrodes after linearly increasing the pre-charge amount in accordance with a distance between the scan electrode driven in the gate driving and a driving point of the data electrode driven in the source driving.

16. The capacitive load driving method according to claim 11, wherein the source driving includes driving each of the data electrodes after exponentially increasing the pre-charge amount in accordance with a distance between the scan electrode driven in the gate driving and a driving point of the data electrode driven in the source driving.

17. The capacitive load driving method according to claim 15, wherein the source driving includes driving each of the data electrodes after setting the pre-charge amount at zero, when the scan electrode nearest to the driving point of the data electrode is driven in the gate driving.

18. The capacitive load driving method according to claim 11, wherein the source driving includes changing the pre-charge amount by controlling a pre-charge time on the basis of the scan electrode driven in the gate driving.

19. The capacitive load driving method according to claim 11, wherein the source driving includes a of changing the pre-charge amount by controlling a pre-charge voltage on the basis of the scan electrode driven in the gate driving.

20. The capacitive load driving circuit according to claim 2, wherein each of the plurality of output circuits drives the corresponding data electrode after linearly increasing the pre-charge amount in accordance with a distance between the scan electrode driven by the gate driver and the output terminal of the output circuit.
